(19) United States
(12) Patent Application Publication
(10) Pub. No.: US 2026/0034436 A1
(43) Pub. Date: Feb. 5, 2026

(54) A HUMAN-INTERFACE DEVICE AND A METHOD FOR HUMAN-MACHINE INTERFACE

(71) Applicant: Tze Yuk Mak, Pok Fu Lam (HK)

(72) Inventor: Tze Yuk Mak, Pok Fu Lam (HK)

(21) Appl. No.: 18/996,375

(22) PCT Filed: Aug. 12, 2022
(86) PCT No.: PCT/CN2022/112031

§ 371 Date: Jan. 17, 2025

(51) Int. Cl. A63F 13/211; A63F 13/212; A63F 13/24

(52) U.S. Cl. CPC A63F 13/211; A63F 13/212; A63F 13/24

(57) ABSTRACT

A human-interface device (HID) and a method for human-machine interface. The HID includes a motion sensing module arranged to detect a motion performed by a user engaged with the HID; an input command translation module arranged to translate the motion detected by the motion sensing module to an input command based on a predetermined motion-command mapping relationship; and an output module arranged to provide the input command to an external device for further processing.

### TECHNICAL FIELD

The invention relates to a human-interface device (HID) and a method for human-machine interface, and particularly, although not exclusively, to a motion controller.

### BACKGROUND

In video games and entertainment systems, a motion controller is a type of game controller that uses motion sensors to track motion and provide input. For example, a user swinging the motion controller may control a character in a video sport game to swing a tennis racket similar to playing real tennis. Depending on the how the user swings the motion controller, the character in the video game performs different actions, such as hitting the tennis ball using forehand or backhand postures, performing a drop shot, serving, etc.

### SUMMARY OF THE INVENTION

In accordance with a first aspect of the present invention, there is provided a human-interface device (HID) comprising: a motion sensing module arranged to detect a motion performed by a user engaged with the HID; an input command translation module arranged to translate the motion detected by the motion sensing module to an input command based on a predetermined motion-command mapping relationship; and an output module arranged to provide the input command to an external device for further processing.

In accordance with the first aspect, the predetermined motion-command mapping relationship comprises a HID-keyboard protocol, and the input command is equivalent to a command provided by a generic computer keyboard.

In accordance with the first aspect, the input command includes an ASCII code command.

In accordance with the first aspect, the predetermined motion-command mapping relationship includes a plurality of input commands matching with, respectively, a plurality of predetermined motions detectable by the motion sensing module.

In accordance with the first aspect, the plurality of predetermined motions includes swinging and/or moving the human-interface device in a three-dimensional space, and/or ceasing the swinging or moving motion of the human-interface device.

In accordance with the first aspect, the plurality of predetermined motions includes swinging and/or moving the human-interface device with different amplitudes/magnitudes.

In accordance with the first aspect, the plurality of predetermined motions include a series of motioned performed.

In accordance with the first aspect, the motion sensing module comprises one or more accelerators and/or gyroscopes.

In accordance with the first aspect, the motion sensing module further comprises an inclinometer, an analogue switch or a digital switch.

In accordance with the first aspect, the human-interface device is a game controller.

In accordance with the first aspect, the human-interface device further comprises an accessory arranged to attach to a housing of the human-interface device.

In accordance with the first aspect, the accessory comprises a universal mount provided with a securing means for releasably securing the universal mount to the housing of the human-interface device, and a second securing means for releasably securing the housing of the human-interface device to other parts of the accessory via the universal mount.

In accordance with the first aspect, the accessory is provided in a form of a toy sword, a balance board, a skateboard, a driving wheel or a strap for engaging the human-interface device to a human body.

In accordance with the first aspect, the accessory comprises a display mount provided with a first securing means for releasably securing the display mount to the housing of the human-interface device, and a second securing means for releasably securing an external device provided with a display module to the display mount.

In accordance with the first aspect, the external device includes a smartphone or a tablet computing device.

In accordance with the first aspect, the accessory comprises a pair of securing means for releasably securing the display mount to the housing of a pair of human-interface devices.

In accordance with the first aspect, the predetermined motion-command mapping relationship includes a plurality of sets of mapping relationship predefined for a plurality of predetermined deployment of the human-interface device.

In accordance with a second aspect of the present invention, there is provided a method for human-machine interface, comprising the step of: detecting a motion performed by a user engaged a human-interface device (HID); translating the detected motion to an input command based on a predetermined motion-command mapping relationship; and providing the input command for further processing.

In accordance with the second aspect, the predetermined motion-command mapping relationship comprises a HID-keyboard protocol, and wherein the input command is equivalent to a command provided by a generic computer keyboard.

In accordance with the second aspect, the predetermined motion-command mapping relationship includes a plurality of input commands matching with, respectively, a plurality of predetermined motions detectable by one or more motion sensors provided in the human-interface device.

### BRIEF DESCRIPTION OF THE DRAWINGS

Embodiments of the present invention will now be described, by way of example, with reference to the accompanying drawings in which:

FIG. 1 is a block diagram of a human-interface device in accordance with an embodiment of the present invention.

FIG. 2 is an illustration showing a human-interface device being held by a user and example operations of the HID in accordance with an embodiment of the present invention; and a flow of operation explaining how a game may be design with motion control inputs.

FIG. 3 is an illustration showing a list of predefined motions, relevant parameters of the motion sensing modules and translated input commands according to a motion-command mapping relationship in accordance with an embodiment of the present invention.

FIG. 4A is a photographic image of a HID being held by a user in accordance with an embodiment of the present invention.

FIG. 4B is a photographic image of the HID of FIG. 4A fastened to a leg of a user.

FIG. 5A is an illustration showing a perspective view of a HID and a universal mount for mounting the HID to an accessory in accordance with an embodiment of the present invention.

FIG. 5B is an illustration showing an exploded view from a first viewing angle of the HID of FIG. 5A.

FIG. 5C is an illustration showing an exploded view from a second viewing angle of the HID of FIG. 5A.

FIG. 5D is an illustration showing an exploded view from a third viewing angle of the HID of FIG. 5A.

FIG. 6A is a photographic image of a HID of FIG. 4A being secured to a toy sword.

FIG. 6B is a photographic image of a HID of FIG. 4A being secured to a skateboard.

FIG. 6C is a photographic image of a HID of FIG. 4A being secured to a balance board.

FIG. 7A is an illustration showing a base of a one hand gun-shaped mount being secured to the HID in accordance with an embodiment of the present invention.

FIG. 7B is an illustration showing a base of a one hand gun-shaped mount being detached from the HID of FIG. 7A.

FIG. 7C is a photographic image of an assembly of the HID of FIG. 4A combined with the one hand gun-shaped mount.

FIG. 7D is a photographic image of a smartphone being secured to the HID of FIG. 4A via the one hand gun-shaped mount.

FIG. 8A is an illustration showing a base of a two-hand gun-shaped mount being secured to a pair of HIDs in accordance with an embodiment of the present invention.

FIG. 8B is an illustration showing a base of a two-hand gun-shaped mount being detached from the HIDs of FIG. 8A.

FIG. 8C is a photographic image of a tablet computer being secured to a pair of HIDs of FIG. 4A via the two-hand gun-shaped mount.

FIG. 8D is a photographic image showing a side view of a tablet computer being secured to a pair of HIDs of FIG. 8C.

### DETAILED DESCRIPTION OF THE PREFERRED EMBODIMENTS

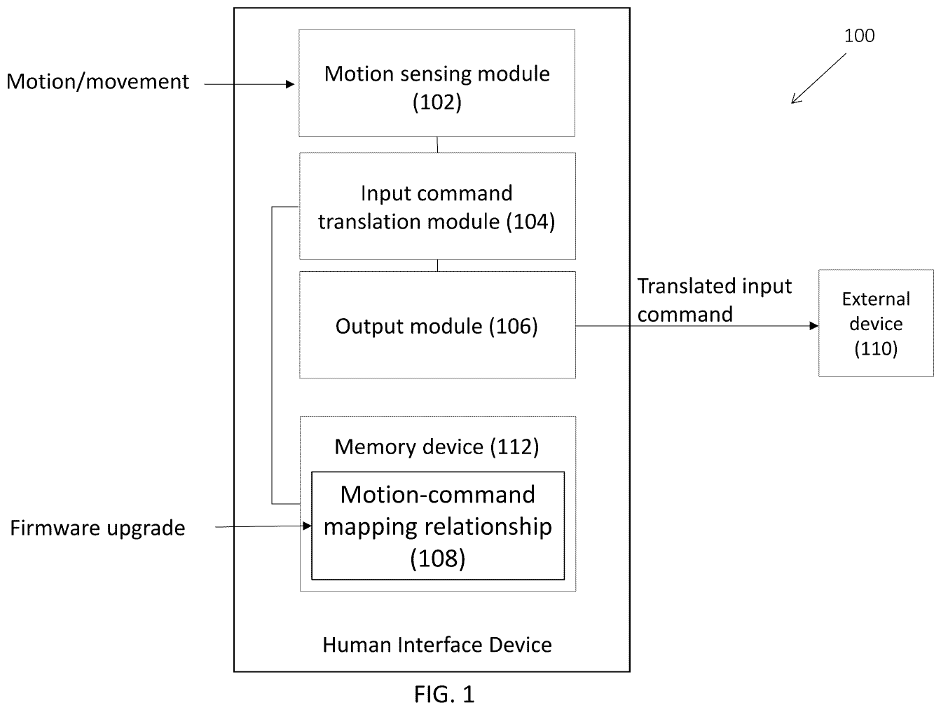

With reference to FIG. 1, there is shown an embodiment of a human-interface device (HID) 100 comprising a motion sensing module 102 arranged to detect a motion performed by a user engaged with the HID 100; an input command translation module 104 arranged to translate the motion detected by the motion sensing module 102 to an input command based on a predetermined motion-command mapping relationship 108; and an output module 106 arranged to provide the input command to an external device 110 for further processing.

In this example, the motion sensing module 102 may comprise electronics housed within the human-interface device, such as inertia measurement units (IMUs), accelerators and/or gyroscope for capturing translational movements as well as angular movements of the HID 100, and the motion sensing module 102 may further provide movement signals associated with the movements upon detecting any movements of the HID 100. For example, accelerators such as a three-axis accelerometer may be used for detecting translational movements in an x-, y- and z-axis in a three-dimensional space, specifically by detecting the acceleration and/or a deceleration in each of these directions, represented by independent signals of different amplitudes indicating the levels of movements in different directions.

Preferably, the motion sensing module 102 is also arranged to detect a movement of an object engaged with the HID 100, for example when the HID 100 is held by a user, the motion sensing module 102 may detect the movement of the user's hand holding or grasping the HID 100. Alternatively, a movement of a target object, such as a balance board may be connected with the HID, and thus the motion sensing module 102 may capture all movements of the balance board when being used. More examples of operations of the HID in different modes will be further described later in this disclosure.

It should be appreciated by a skilled person in the art that the movement signals provided by the motion sensing module may be in any forms including analogue signals or digital signals, with or without being processed by suitable signal convertors, such as but not limited to an analogue-to-digital (or vice versa) convertor.

The HID 100 further comprises input command translation module 104 arranged to translate the motion detected by the motion sensing module 102 to an input command, such as an ASCII command or code that may be represented in binary or hexidecimal “numbers”. In this example, the raw signals or processed signals provided by the motion sensing module 102 are digital or analogue signals which are not readily “understood” by a computing device, may be translated to binary or hexidecimal signals which may be readily processed by any computing device such as a computer server, a laptop computer, a laptop computer, a smartphone, or even a gaming console which is built with components similar to a generic computer.

For example, when the HID 100 is held by a user in his hand, the motion sensing module 102 may pickup different motions of the user's hand when the user swings the motion controller or the HID 100, e.g. the user may swing the HID 100 from left to right or from right to without twisting or turning (e.g. changing the orientation of the HID). These motions captured by the motion sensing module 102 may be translated into, respectively, ASCII codes such as “01010001” representing letter “Q” and “01010111” representing letter “W” on an HID keyboard or generic computer keyboard.

Without wishing to be bound by theory, the input command translation module 104 may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

In addition, the translation may be based on a predetermined motion-command mapping relationship 108, such that specific “instruction sets” associated with different motions may be translated into a plurality of input commands, e.g. keyboard inputs of different letters or symbols as described earlier. For example, the motion-command mapping relationship 108 may be stored in a memory device 112 accessible by the input command translation module 104, so that the input command translation module 104 may look up a matching input command upon receiving certain motion signal provided by the motion sensing module 102. Alternatively, the memory device 112 may be implemented as a sub-module of the input command translation module 104.

The HID 100 further comprises an output module 106 arranged to provide the input command to an external device 110 for further processing. For example the output module 106 may be a bus or an interface arranged to facilitate transmission of the input command or the keyboard letter to an external processing device 110, such as one or more computing devices including server computers, personal computers, laptop computers, or mobile computing devices such as smartphones and tablet computers. Alternatively, the output module 106 may include a communication link, supported by a Bluetooth communication module or other types or wireless communication modules, arrange to support transmission of the input command or the keyboard letter to the external device 110.

Alternatively, other generic HID protocols or HID-keyboard protocols may be used, without departing from the spirit or scope of the invention. Preferably, the external device 110 is arranged to readily process the input command similar to processing commands provided by a generic computer keyboard or other generic HID without requiring special driver to be installed.

For example, a computer system or computer server may be implemented as an example embodiment of an external device 110 arranged to receive input commands from the HID 100. The system may comprise suitable components necessary to receive, store and execute appropriate computer instructions. The components may include a processing unit, including Central Processing United (CPUs), Math Co-Processing Unit (Math Processor), Graphic Processing United (GPUs) or Tensor processing united (TPUs) for tensor or multi-dimensional array calculations or manipulation operations, read-only memory (ROM), random access memory (RAM), and input/output devices such as disk drives, input devices such as an Ethernet port, a USB port, etc.

The external device 110 may also include storage devices such as a disk drive which may encompass solid state drives, hard disk drives, optical drives, magnetic tape drives or remote or cloud-based storage devices. The external device 110 may use a single disk drive or multiple disk drives, or a remote storage service. The external device 110 may also have a suitable operating system which resides on the disk drive or in the ROM of the server.

Display such as a liquid crystal display, a light emitting display or any other suitable display and communications links may also be provided. The external device 110 may include instructions that may be included in ROM, RAM or disk drives and may be executed by the processing unit. There may be provided a plurality of communication links which may variously connect to one or more computing devices such as a server, personal computers, terminals, wireless or handheld computing devices, Internet of Things (IoT) devices, smart devices, edge computing devices. At least one of a plurality of communications link may be connected to an external computing network through a telephone line or other type of communications link.

Alternatively, other generic HID (keyboard) protocols may be used, without departing from the spirit or scope of the invention. Advantageously, the present invention makes a development of motion-sensing video games, or software applications associated with motion controls become much easier.

The inventor devises that developments of motion-sensing games may be complicated, as the developers may need to know how to develop game software, and they also need to know how to use a motion sensor to capture the player's motion and perform calculations, e.g. by “decoding” the motion signals provided by accelerators and gyroscopes embedded in the motion controller. Advantageously, the invention implemented with the input command translation module may simplify this problem.

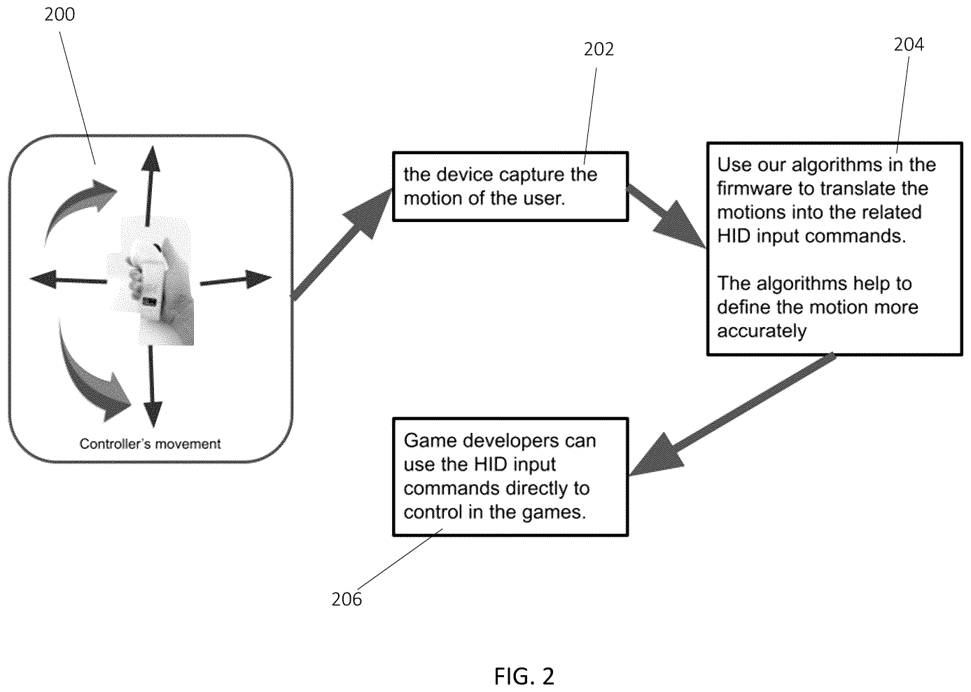

With reference to FIG. 2, upon sensing a motion of the user or a game player illustrated in block 202, the player's motions as shown in block 200 may be further converted into preset game input commands according to a HID Protocol in block 204, and the input commands may be further provided to a computing device such as a game console. Advantageously, developers may simply design the game or the software application with HID commands instead of detecting the player motions, as shown in block 206, which effectively reduces the time consumed on game development. Also, game developers are not necessary to have motion-sensing hardware knowledge as the software is simply designed with input commands not substantially different from keyboard commands or other generic HID commands/protocols.

In addition, the HID keyboard protocol is also compatible with different devices running various operation systems such as Windows, Android, Macos, iOS or other proprietary OS directly without drivers or plugin, thus game developers do not have to worry about the compatibility in different devices.

For example, the HID may be used as a motion controller or a game controller, and the HID may perform a method for human-machine interface, comprising the step of: detecting a motion performed by a user engaged a human-interface device (HID); translating the detected motion to an input command based on a predetermined motion-command mapping relationship; and providing the input command for further processing.

Preferably, the predetermined motion-command mapping relationship includes a plurality of input commands matching with, respectively, a plurality of predetermined motions detectable by the motion sensing module 102. Example motions may include swinging and/or moving the human-interface device in a three-dimensional space, and/or ceasing the swinging or moving motion of the human-interface device.

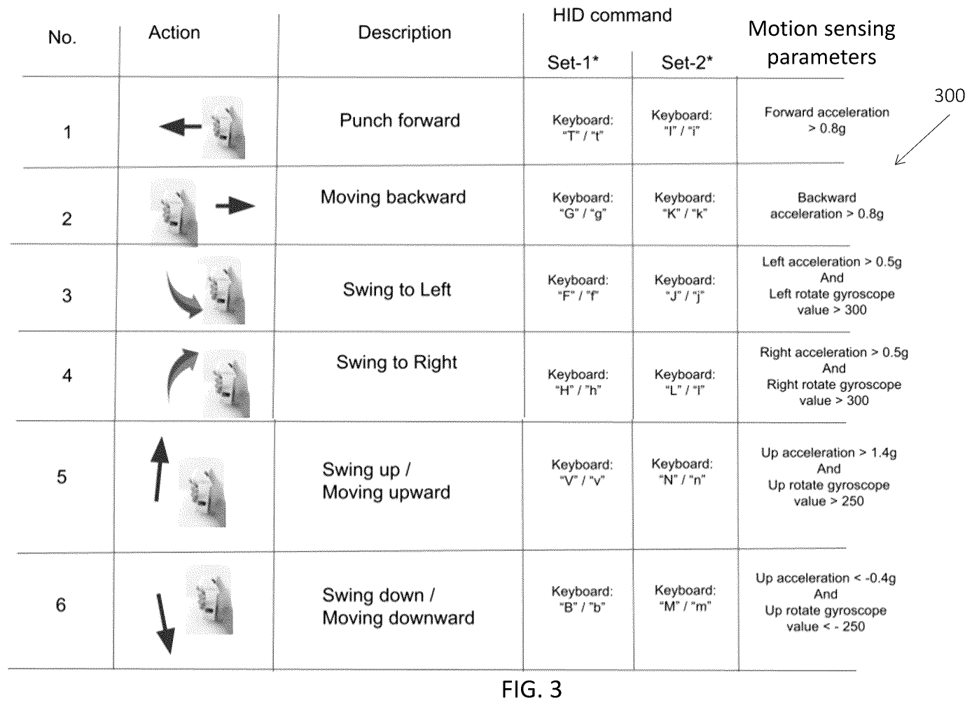

With reference to FIG. 3, there is shown an example motion-command mapping relationship, in which six predetermined motions including “punch forward”, “moving backward”, “swing to left”, “swing to right”, “swing up” (or moving upward) and “swing down” (or moving download), may be translated to, respectively, six different keyboard keys of T, G, F, H, V and B, according to the mapping relationship. Alternatively, the motion-sensing game controller may be switched from “Set-1” for left hands and “Set-2” for right hands, depending on the game design, and accordingly the six motions are respectively translated to another set of keys of I, K, J, L, N and M respectively.

Preferably, the predetermined motion-command mapping relationship may include a plurality of sets of mapping relationship predefined for a plurality of predetermined deployment of the human-interface device.

Preferably, the six predetermined motions including “punch forward”, “moving backward”, “swing to left”, “swing to right”, “swing up” (or moving upward) and “swing down” (or moving download), may be captured by “reading” the motion signals provided by the motion sensing module 102. For example, when a user holds a motion controller in his hand, a forward acceleration detected by an accelerometer with an amplitude greater than 0.8 g may indicate a “punch forward” movement, and a backward acceleration detected by the accelerometer with an amplitude greater than 0.8 g may indicate a “moving backward” movement.

In addition, the plurality of predetermined motions includes swinging and/or moving the human-interface device with different amplitudes/magnitudes. For example, the motion related to swinging the controller left or right may be represented by a smaller acceleration of greater than 0.5 g, and a signal of >300 provided by the gyroscope. Alternatively, the motions related to swinging up may require a stronger upward motion to trigger, as an upward acceleration of greater than 1.4 g may be considered valid, but the downward movement may only require 0.4 g downward acceleration to trigger.

Optionally, it is also possible that different HID command may be produced if similar motions are performed with different amplitudes/magnitudes. For example, a light punch may be recognized if a forward acceleration of 0.8 g is detected, and an input command of small letter “p” is outputted to the external device, and a heavy punch may be recognized if a forward acceleration of 1.6 g is detected, and an input command of capital letter “P” is outputted to the external device, in accordance with an alternative motion-command mapping relationship.

In yet an alternative example, the plurality of predetermined motions may include a series of motioned performed, for example a single keyboard letter or HID command may be produced if a combo of “swing down” followed by “swing up” motions are captured, or the input commands may include a series of keys or letters matching with a respective motion in the motion-command mapping relationship.

When the player moves the controller, the output module 106 of the HID outputs a specific HID keyboard command. Thus, instead of handling complex motion detection, game developers just need to monitor the HID keyboard command during the gameplay. This can greatly reduce the workload of game developers, and may further expedite game development processes, since game developers are only required to consider how the software or game work with input commands similar to keyboard letters or symbols.

Preferably, the motion-command mapping relationship 108 may be further provided, by matching the keyboard input command to the desired set of motions, and the motion-command mapping relationship 108 may be stored in the HID 100 or accessible by the HID when the software or game is launched. For example, the motion-command mapping relationship 108 may be provided to customer as a bundle when the main part of the software is purchased or downloaded, and by launching the software, the necessary motion-command mapping relationship 108 may be further downloaded to the HID 100, so that the motion sensing module 102 may accurately translate the detected motion to the required input commands, based on the motion-command mapping relationship 108 designed for the respective software.

Alternatively, one or more “standard” instruction sets or motion-command mapping relationships 108 may be provided to game developers, such as the standard motions and keys as illustrated in FIG. 3, so that game developers may design the game or software according to the standard instruction sets. In this example, it may only be necessary to call the appropriate motion-command mapping relationships, e.g., set-I and set-II designed for a game play experience with a pair of motion controllers being held respectively in the left and the right hands of the user. In an alternative example, other motion-command mapping relationships representing different combinations of predefined motions/motion signals and HID commands. The standard instruction sets stored in the HID 100 may be updated by means of firmware upgrade if necessary.

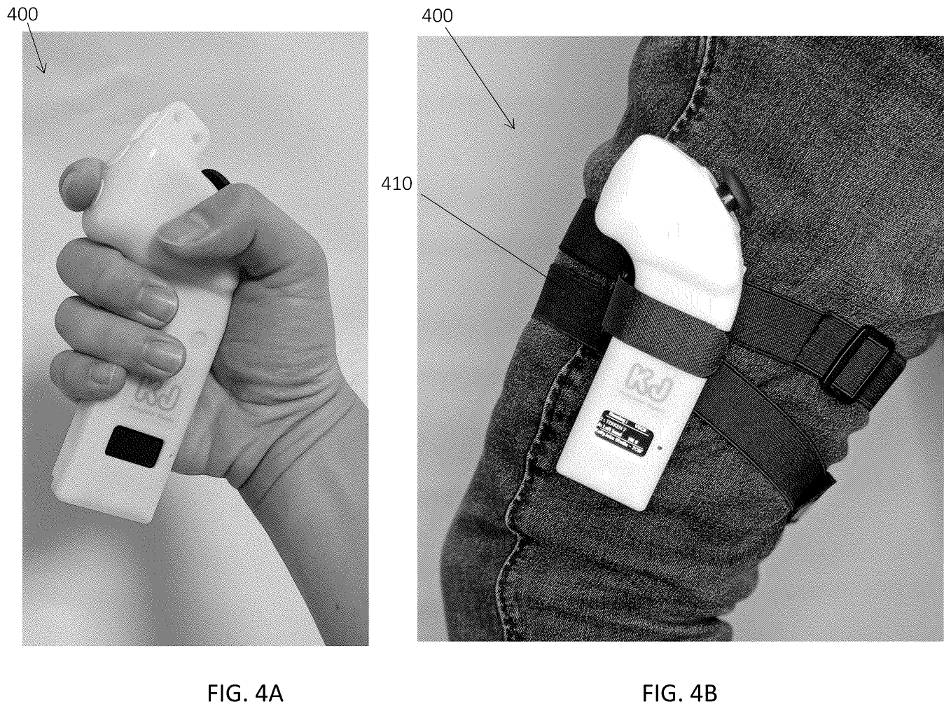

The inventor devised that, in order to enhance user experiences, the HID 400 may be “engaged” to a user using different attachments, besides allowing it to be held in hands referring to FIG. 4A. For example, it can be attached to toy swords, rackets, legs, skateboards, balance boards, Gun-shaped mounts. With reference to FIG. 4B, the HID may be attached to a leg of the user via a strap.

Preferably, the device is designed to be easily attached, via an accessory arranged to attach to a housing of the human-interface device. The accessory may include a universal mount, which may be provided with a first securing means for releasably securing the universal mount to the housing of the human-interface device, and a second securing means for releasably securing the housing of the human-interface device to other parts of the accessory via the universal mount.

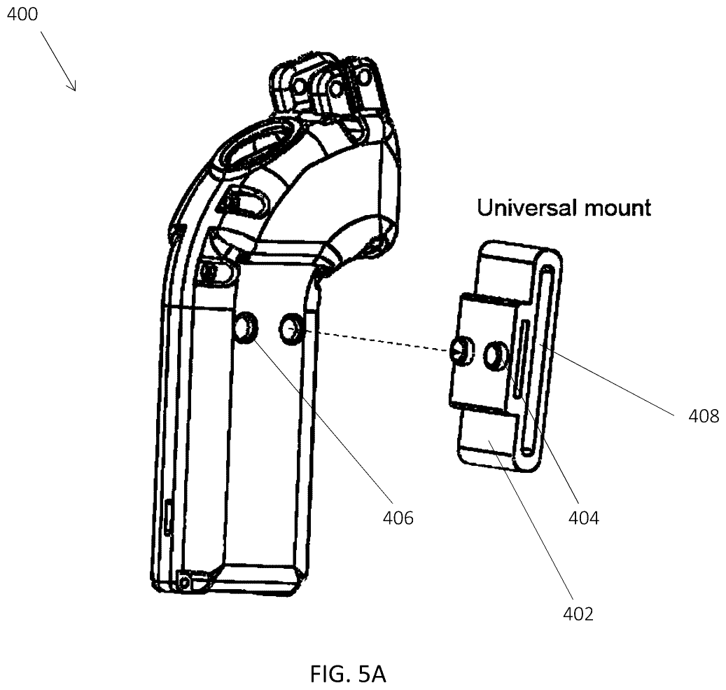

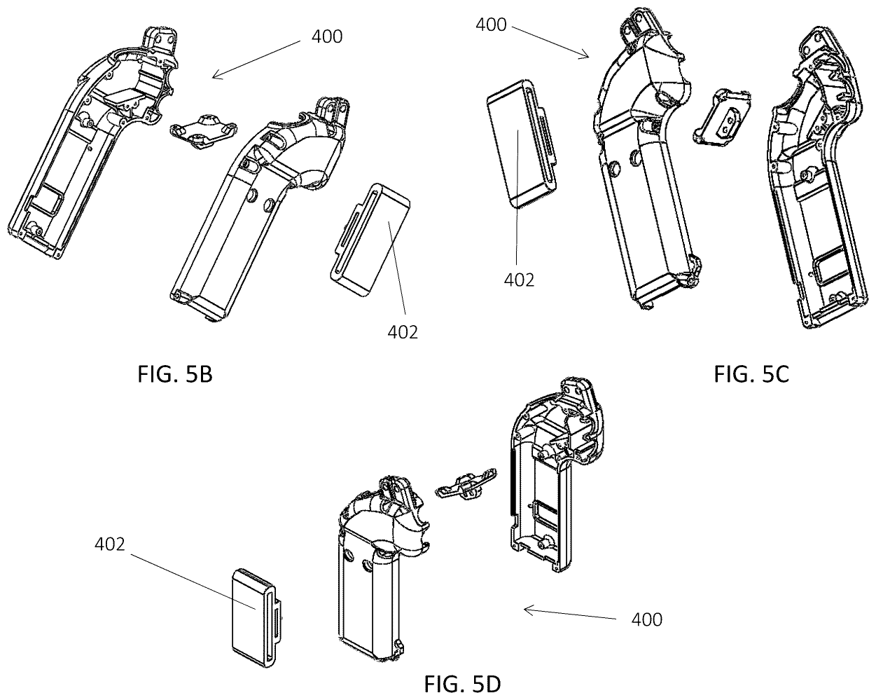

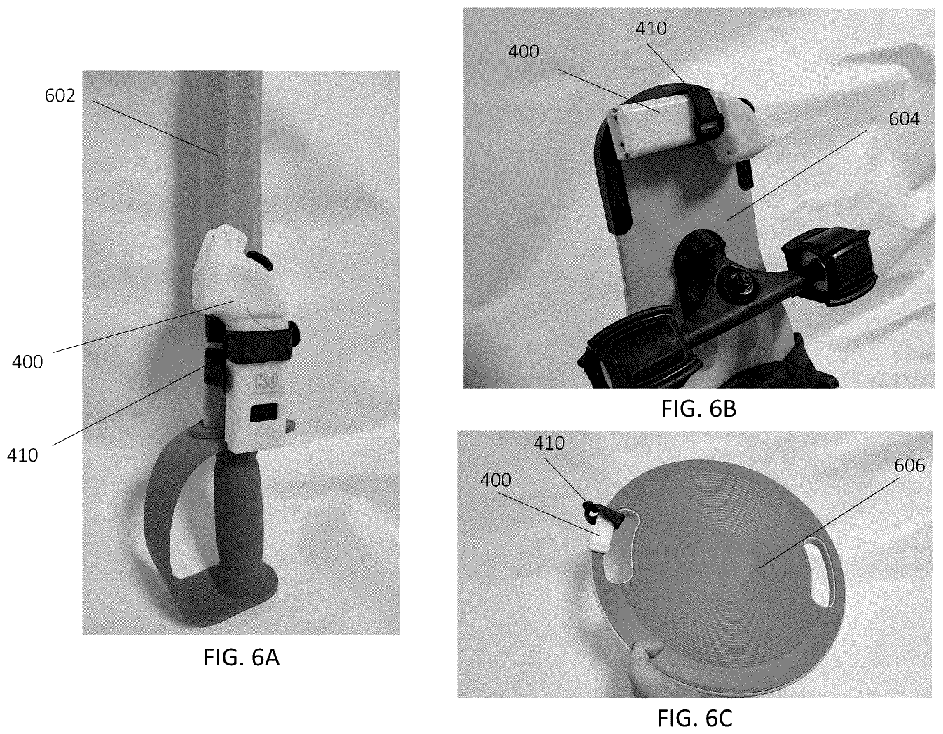

Referring to FIGS. 5A to 5D, the universal mount 402 which includes buttons or protrusions 404 that match with grooves or dents 406 provided on the housing of the HID 400. The universal mount 402 also includes a slot or an aperture 408 which allow a strap passing through. Advantageously, the strap may be used to secure the HID 400 to other parts of the accessory, which may be provided in a form of a toy sword, a balance board, a skateboard, a driving wheel. Alternatively, the accessory, such as the toy sword, the balance board and skateboard as shown in FIGS. 6A to 6C, may include suitable securing means for directly attaching the HID thereon.

Referring to FIG. 6A, the accessory is provided in a form of a toy sword 602. The HID 400 is secured at a position near the grip of the toy sword 602 using the fastening strap 410 such that the toy sword 602 and the HID 400 is fastened together via the strap 410 and the universal mount. During game play, the user may swing the toy sword 602 and the movements of the HID 400 may be captured by the motion sensing module, in turn the HID 400 may further provide translated input command for further processing if the captured motions match with any input commands according to the motion-command mapping relationships designed for the software.

Referring to FIG. 6B, the accessory is provided in a form of a skateboard 604. The HID 400 is secured at the bottom the skateboard 604 near the head using the fastening strap such that the skateboard 604 and the HID 400 is fastened together via the strap 410 and the universal mount. During game play, the user may stand on the skateboard 604 and the movements of the HID 400 may be captured by the motion sensing module 102, in turn the HID 400 may further provide translated input command for further processing if the captured motions match with any input commands according to the motion-command mapping relationships designed for the software.

Referring to FIG. 6C, the accessory is provided in a form of a balance board 606. The HID 400 is secured on the top the balance board 606 at a side using the fastening strap 410 such that the balance board 606 and the HID is fastened together via the strap 410 and the universal mount. During game play, the user may stand on the balance board 606 and the movements of the HID 400 may be captured by the motion sensing module 102, in turn the HID 400 may further provide translated input command for further processing if the captured motions match with any input commands according to the motion-command mapping relationships designed for the software.

Alternatively or additionally, the accessory may comprise a display mount provided with a first securing means for releasably securing the display mount to the housing of the human-interface device, and a second securing means for releasably securing an external device provided with a display module to the display mount.

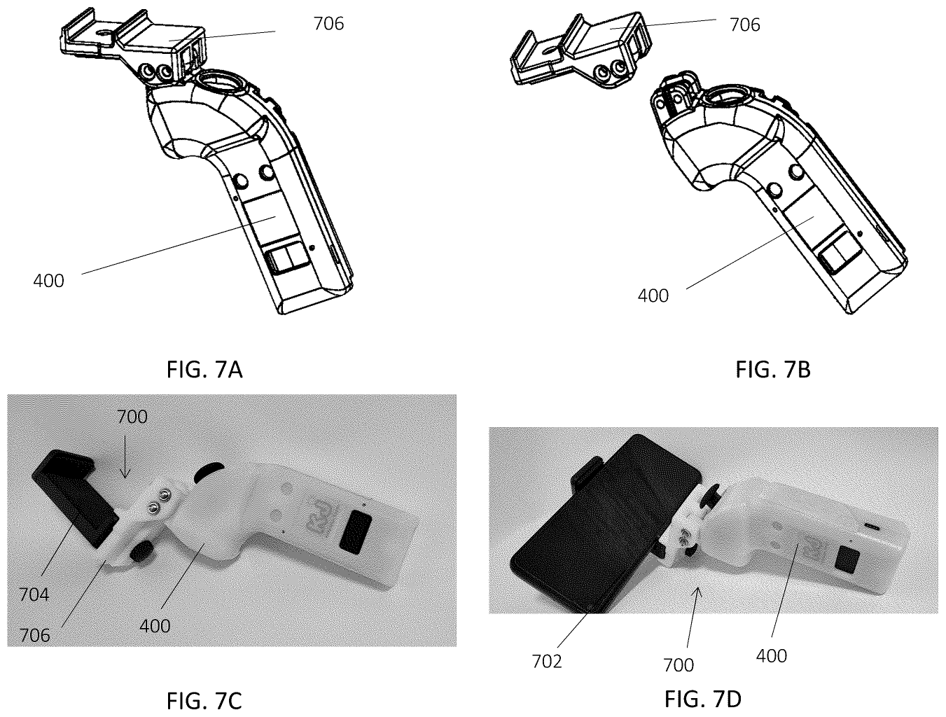

With reference to FIGS. 7A to 7D, the accessory may be an “one hand gun-shaped mount” 700. By attaching the HID 400 to a one hand gun-shaped mount 700, users may attach the HID 400 to a mobile phone 702 for gaming. Alternatively, a larger mount may be used for mounting a tablet computer to the HID 400 for gaming.

In this example, the accessory is a display mount 700 including a gripping means 704 arranged to releasably secure the phone 702 by gripping, similar to those provided in a selfie stick. The gripping means 704 may be secured to a base 706 which may be secured to the housing of the HID 400, e.g. via screws and bolts or other suitable fastening means as appreciated by a skilled person.

Optionally, the motion sensing module further comprises an inclinometer, an analogue switch or a digital switch, and motions associated with inputs such as tilting the HID, moving an analogue stick and/or pressing a button may be captured by the motion sensing module, so that more types of motions may be incorporated as valid input for different types of software or games. For example, tilting the HID downwardly then upward may be consider a “reload” action, pushing the analogue stick may be considered as “move forward” and pressing a digital switch using an index finger may be considered as “pulling a trigger” in a game playing where the player hold a pistol.

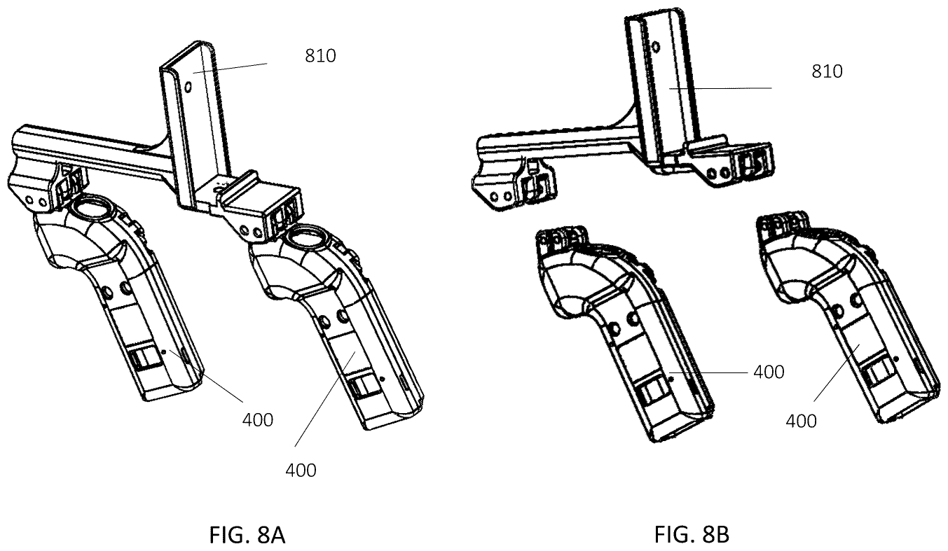

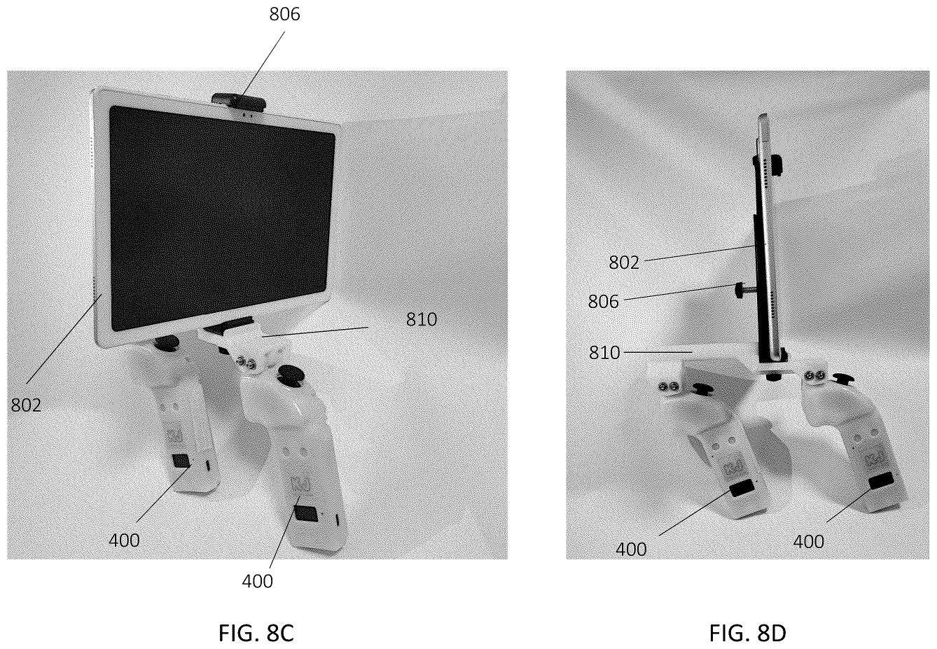

In an alternative example, a “two-hand gun-shaped mount” 800 is provided, in which a user may attach a tablet 802 during gaming. With reference to FIGS. 8A to 8D, the accessory comprises a pair of securing means for releasably securing the display mount 806 to the housing of a pair of human-interface devices 400, so that the combination of the two HIDs, and the mounted tablet computer is best held using both hands, one at a position in front of another hand, similar to holding a rifle.

In this example, the accessory is a display mount 800 including a gripping means 806 arranged to releasably secure the tablet 802 by gripping, similar to the “one hand gun-shaped mount” 700 with a larger grip for a tablet computer with a larger screen. The gripping means 806 may be secured to a base 810 which may be secured to the housing of the HID 400, e.g. via screws and bolts or other suitable fastening means as appreciated by a skilled person. Alternatively, a smaller gripping means may be attached to the base if a user prefers using a smartphone with a smaller screen for a different game play experience.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilised. This will include tablet computers, wearable devices, smart phones, Internet of Things (IoT) devices, edge computing devices, stand-alone computers, network computers, cloud-based computing devices and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A human-interface device (HID) comprising:
a motion sensing module arranged to detect a motion performed by a user engaged with the HID;
an input command translation module arranged to translate the motion detected by the motion sensing module to an input command based on a predetermined motion-command mapping relationship; and
an output module arranged to provide the input command to an external device for further processing.

2. The human-interface device in accordance with claim 1, wherein the predetermined motion-command mapping relationship comprises a HID-keyboard protocol, and wherein the input command is equivalent to a command provided by a generic computer keyboard.

3. The human-interface device in accordance with claim 2, wherein the input command includes an ASCII code command.

4. The human-interface device in accordance with claim 3, wherein the predetermined motion-command mapping relationship includes a plurality of input commands matching with, respectively, a plurality of predetermined motions detectable by the motion sensing module.

5. The human-interface device in accordance with claim 4, wherein the plurality of predetermined motions includes swinging and/or moving the human-interface device in a three-dimensional space, and/or ceasing the swinging or moving motion of the human-interface device.

6. The human-interface device in accordance with claim 5, wherein the plurality of predetermined motions includes swinging and/or moving the human-interface device with different amplitudes/magnitudes.

7. The human-interface device in accordance with claim 5, wherein the plurality of predetermined motions include a series of motioned performed.

8. The human-interface device in accordance with claim 1, wherein the motion sensing module comprises one or more accelerators and/or gyroscopes.

9. The human-interface device in accordance with claim 8, wherein the motion sensing module further comprises an inclinometer, an analogue switch or a digital switch.

10. The human-interface device in accordance with claim 1, wherein the human-interface device is a game controller.

11. The human-interface device in accordance with claim 10, further comprising an accessory arranged to attach to a housing of the human-interface device.

12. The human-interface device in accordance with claim 11, wherein the accessory comprises a universal mount provided with a first securing means for releasably securing the universal mount to the housing of the human-interface device, and a second securing means for releasably securing the housing of the human-interface device to other parts of the accessory via the universal mount.

13. The human-interface device in accordance with claim 13, wherein the accessory is provided in a form of a toy sword, a balance board, a skateboard, a driving wheel or a strap for engaging the human-interface device to a human body.

14. The human-interface device in accordance with claim 10, wherein the accessory comprises a display mount provided with a first securing means for releasably securing the display mount to the housing of the human-interface device, and a second securing means for releasably securing an external device provided with a display module to the display mount.

15. The human-interface device in accordance with claim 14, wherein the external device includes a smartphone or a tablet computing device.

16. The human-interface device in accordance with claim 14, wherein the accessory comprises a pair of securing means for releasably securing the display mount to the housing of a pair of human-interface devices.

17. The human-interface device in accordance with claim 1, wherein the predetermined motion-command mapping relationship includes a plurality of sets of mapping relationship predefined for a plurality of predetermined deployment of the human-interface device.

18. A method for human-machine interface, comprising the step of:
detecting a motion performed by a user engaged a human-interface device (HID);
translating the detected motion to an input command based on a predetermined motion-command mapping relationship; and
providing the input command for further processing.

19. The method in accordance with claim 18, wherein the predetermined motion-command mapping relationship comprises a HID-keyboard protocol, and wherein the input command is equivalent to a command provided by a generic computer keyboard.

20. The method in accordance with claim 19, wherein the predetermined motion-command mapping relationship includes a plurality of input commands matching with, respectively, a plurality of predetermined motions detectable by one or more motion sensors provided in the human-interface device.
